(19) United States
(12) Patent Application Publication
(10) Pub. No.: US 2008/0111779 A1
(43) Pub. Date: May 15, 2008

(54) LIQUID-CRYSTAL DISPLAY, METHOD FOR PRODUCING LIQUID-CRYSTAL DISPLAY, AND ELECTRONIC DEVICE

(75) Inventor: Tomotaka MATSUMOTO, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/850,095

(22) Filed: Sep. 5, 2007

(30) Foreign Application Priority Data
Nov. 13, 2006 (JP) 2006-306394

(51) Int. Cl. G09G 3/36; G02F 1/1333

(52) U.S. Cl. 345/87; 349/56

(57) ABSTRACT

A liquid-crystal display, having a plurality of pixel areas and a plurality of photodetection areas for detecting light disposed in a two-dimensional manner, includes first switching elements each provided for the corresponding pixel area and switching the drive of the corresponding pixel area, and second switching elements formed on the same layer as the first switching elements and each switching a photosensor element provided for the corresponding photodetection area. First sensor electrodes connected to the photosensor elements are formed on the same layer as switching electrodes connected to the second switching elements.

### BACKGROUND

1. Technical Field

The present invention relates to liquid-crystal displays having a function of, for example, reading images, relates to methods for producing liquid-crystal displays, and relates to electronic devices.

2. Related Art

To date, liquid-crystal displays have been used as display systems for electronic devices such as portable information terminals. Among such liquid-crystal displays, JP-A-2006-3857, for example, describes a liquid-crystal display having a function of reading images using photodetection areas having contact area sensors such as photosensor elements capable of photoelectric conversion. In this liquid-crystal display, thin-film transistor (TFT) elements, which serve as switching elements for driving pixel areas and photodetection areas, and the photosensor elements are mainly composed of polycrystalline silicon, and the TFT elements and the photosensor elements are formed in one step.

However, the production process of the above-described liquid-crystal display is disadvantageously complicated since light-shielding films, which prevent a reduction in the detection accuracy of the photosensor elements caused when the photosensor elements receive backlight, are disposed outside the photosensor elements. Moreover, since the photosensor elements are mainly composed of polycrystalline silicon as are the TFT elements, flexibility in designing the photosensor elements is disadvantageously reduced.

### SUMMARY

An advantage of some aspects of the invention is that a liquid-crystal display, a method for producing the liquid-crystal display, and an electronic device including the liquid-crystal display are provided such that the production process of the liquid-crystal display can be simplified and flexibility can be improved in designing photosensor elements.

According to a first aspect of the invention, a liquid-crystal display, having a plurality of pixel areas and a plurality of photodetection areas for detecting light disposed in a two-dimensional manner, includes first switching elements each provided for the corresponding pixel area and switching the drive of the corresponding pixel area, and second switching elements formed on the same layer as the first switching elements and each switching a photosensor element provided for the corresponding photodetection area. First sensor electrodes connected to the photosensor elements are formed on the same layer as switching electrodes connected to the second switching elements.

According to a second aspect of the invention, a method for producing a liquid-crystal display having a plurality of pixel areas and a plurality of photodetection areas for detecting light disposed in a two-dimensional manner includes forming of first switching elements that drive the pixel areas and second switching elements that drive the photodetection areas on the same layer, and forming of photosensor elements driven by the second switching elements. First sensor electrodes connected to the photosensor elements are formed on the same layer as switching electrodes connected to the second switching elements.

According to the above-described aspects of the invention, the electrodes connected to the photosensor elements are formed on the same layer as the electrodes connected to the second switching elements during forming of the photosensor elements on a layer different from that on which the first and second switching elements that control switching are formed. With this, the production process of the liquid-crystal display having the photodetection areas can be simplified. That is, the switching electrodes and the sensor electrodes are formed in one step, resulting in simplification of the production process of the liquid-crystal display. In addition, flexibility in designing the photosensor elements can be improved, and photosensor elements with higher sensitivity can be formed in the detection areas by forming the photosensor elements on the layer different from that on which the first and second switching elements are formed.

In the liquid-crystal display according to the first aspect of the invention, the first sensor electrodes are preferably composed of a light-reflective material or a light-absorptive material, and cover the lower surfaces of the photosensor elements. With this structure, the sensor electrodes can function as light-shielding films, and can prevent the photosensor elements from detecting light incident on the liquid-crystal display at a side adjacent to the lower surfaces of the photosensor elements. Thus, the accuracy in photodetection in the photodetection areas can be improved.

Moreover, in the liquid-crystal display according to the first aspect of the invention, second sensor electrodes connected to the photosensor elements are preferably formed on the same layer as display electrodes provided for the pixel areas. With this structure, the other sensor electrodes and the display electrodes can be formed in one step, resulting in further simplification in the production process of the liquid-crystal display.

Moreover, in the liquid-crystal display according to the first aspect of the invention, the first switching elements and the second switching elements can be thin-film transistors. With this structure, the driving speed of the first and second switching elements can be enhanced as compared with the case where the first and second switching elements are formed of diodes.

Moreover, in the liquid-crystal display according to the first aspect of the invention, the first switching elements and the second switching elements can be mainly composed of polycrystalline silicon. According to the first aspect of the invention, the first and second switching elements and the photosensor elements can be separately designed. Thus, the first and second switching elements can be mainly composed of polycrystalline silicon so as to enhance the driving speed thereof.

Moreover, in the liquid-crystal display according to the first aspect of the invention, the photosensor elements are preferably multilayer PIN diodes. With this, the efficiency in photodetection can be improved.

Moreover, in the liquid-crystal display according to the first aspect of the invention, it is preferable that the photosensor elements be mainly composed of amorphous silicon. According to the first aspect of the invention, the photosensor elements and the first and second switching elements can be separately designed. Thus, the photosensor elements can be mainly composed of amorphous silicon so as to further improve the efficiency in photodetection.

Moreover, the liquid-crystal display according to the first aspect of the invention preferably includes a planarizing film formed on the first switching elements, the second switching elements, and the photosensor elements so as to flatten the surfaces of the elements, and an alignment film formed on the planarizing film so as to regulate the initial orientation of liquid-crystal molecules. According to the first aspect of the invention, orientation treatment can be uniformly applied to the surface of the alignment film since the surfaces of the first and second switching elements and the photosensor elements are flattened by the planarizing film. This can prevent irregularity in the initial orientation of the liquid-crystal molecules. That is, the planarizing film can cancel the differences in level among the upper surfaces of the first and second switching elements and the photosensor elements caused by the first and second switching elements and the photosensor elements formed on different layers. Thus, unevenness in the orientation can be regulated, and the initial orientation of the liquid-crystal molecules can be made uniform.

According to a third aspect of the invention, an electronic device includes the above-described liquid-crystal display. As described above, the first electrodes connected to the photosensor elements are formed on the same layer as the switching electrodes connected to the second switching elements. With this, the production process of the liquid-crystal display having the photodetection areas can be simplified, and thus the liquid-crystal display can be produced at low costs.

### BRIEF DESCRIPTION OF THE DRAWINGS

The invention will be described with reference to the accompanying drawings, wherein like numbers reference like elements.

FIG. 1 is an equivalent circuit diagram illustrating a liquid-crystal display according to an embodiment of the invention.

FIG. 2 is a plan view illustrating a sub-pixel area and a photodetection area.

FIG. 3 is a cross-sectional view taken along line III-III in FIG. 2.

FIG. 4 is a cross-sectional view taken along line IV-IV in FIG. 2.

FIGS. 5A to 5C illustrate a production process of the liquid-crystal display.

FIGS. 6A and 6B illustrate the production process of the liquid-crystal display.

FIG. 7 is an external view of a personal computer including the liquid-crystal display.

FIG. 8 is a cross-sectional view illustrating the structure of another photodetection area to which the invention is applicable.

### DESCRIPTION OF EXEMPLARY EMBODIMENTS

A liquid-crystal display according to an embodiment of the invention will now be described with reference to the drawings. In the drawings, the magnification scales are varied as appropriate so as to facilitate the identification of components shown in the drawings.

### Liquid-Crystal Display

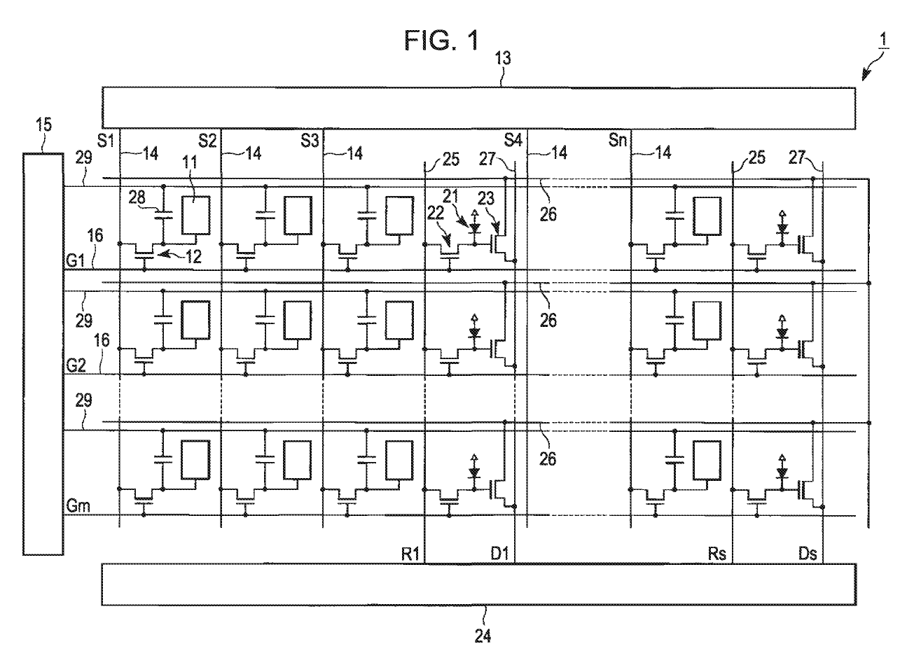

A liquid-crystal display 1 according to this embodiment is a color liquid-crystal display system, and includes pixels each including three sub-pixel areas that emit red (R), green (G), and blue (B) light and a photodetection area. Herein, a display area serving as a minimum unit for the display is referred to as “sub-pixel area (pixel area)”. First, the outline of structure of the liquid-crystal display 1 will be described. As shown in FIG. 1, the liquid-crystal display 1 includes a matrix of a plurality of sub-pixel areas that constitute an image display area and photodetection areas. The sub-pixel areas each include a pixel area (display electrode) 11 and a TFT element (first switching element) 12 for switching the pixel area 11. The sources, gates, and drains of the TFT elements 12 are connected to corresponding data lines 14 extending from a data-line driving circuit 13 provided for the liquid-crystal display 1, corresponding scanning lines 16 extending from a scanning-line driving circuit 15 provided for the liquid-crystal display 1, and the corresponding pixel areas 11, respectively.

The photodetection areas each include a photosensor element 21, a TFT element (second switching element) 22 for switching the photosensor element 21, and a TFT element 23 for amplifying the current converted from light in the photosensor element 21. The sources, gates, and drains of the TFT elements 22 are connected to corresponding reset lines 25 extending from a photodetection-control circuit 24 provided for the liquid-crystal display 1, the corresponding scanning lines 16 extending from the scanning-line driving circuit 15, and the corresponding photosensor elements 21, respectively. Moreover, the sources, gates, and drains of the TFT elements 23 are connected to corresponding power lines 26 that supplies bias voltage to the TFT elements 23, the corresponding photosensor elements 21, and corresponding sensor lines 27 extending from the photodetection-control circuit 24 provided for the liquid-crystal display respectively.

The data-line driving circuit 13 supplies image signals S1, S2, . . . , Sn to the sub-pixel areas via the data lines 14. Herein, the image signals S1 to Sn can be line-sequentially supplied by the data-line driving circuit 13 in this order, or can be supplied to groups of adjacent data lines 14. The scanning-line driving circuit 15 supplies scanning signals G1, G2, . . . , Gm to the sub-pixel areas via the scanning lines 16. Herein, the scanning signals G1 to Gm are line-sequentially supplied by the scanning-line driving circuit 15 at a predetermined timing in a pulsed manner. The photodetection-control circuit 24 supplies reset signals R1, . . . , Rs to the photodetection areas via the reset lines 25, and receives detection signals D1, . . . , Ds from the photodetection areas via the sensor lines 27.

In the liquid-crystal display 1, the image signals S1 to Sn supplied via the data lines 14 are written in the pixel areas 11 at a predetermined timing by switching the TFT elements 12, which are switching elements, on during a predetermined period in response to the input of the scanning signals G1 to Gm. The image signals S1 to Sn at a predetermined level written in liquid crystal via the pixel areas 11 are maintained between the pixel areas 11 and a common electrode 64 (described below) during a predetermined period. In order to prevent the image signals S1 to Sn from leaking, storage capacitors 28 are connected in parallel with liquid-crystal capacitors formed between the pixel area 11 and the common electrode 64. These storage capacitors 28 are disposed between the drains of the corresponding TFT elements 12 and corresponding capacitor lines 29. In the liquid-crystal display 1, the reset signals R1 to Rs are supplied to the TFT elements 23 via the reset lines 25 at a predetermined timing by switching the TFT elements 12 on during a predetermined period in response to the input of the scanning signals G1 to Gm. Furthermore, the TFT elements 23 amplify the currents according to the amount of light that is incident on the photosensor elements 21, and outputs the currents as the detection signals D1 to Ds to the sensor lines 27.

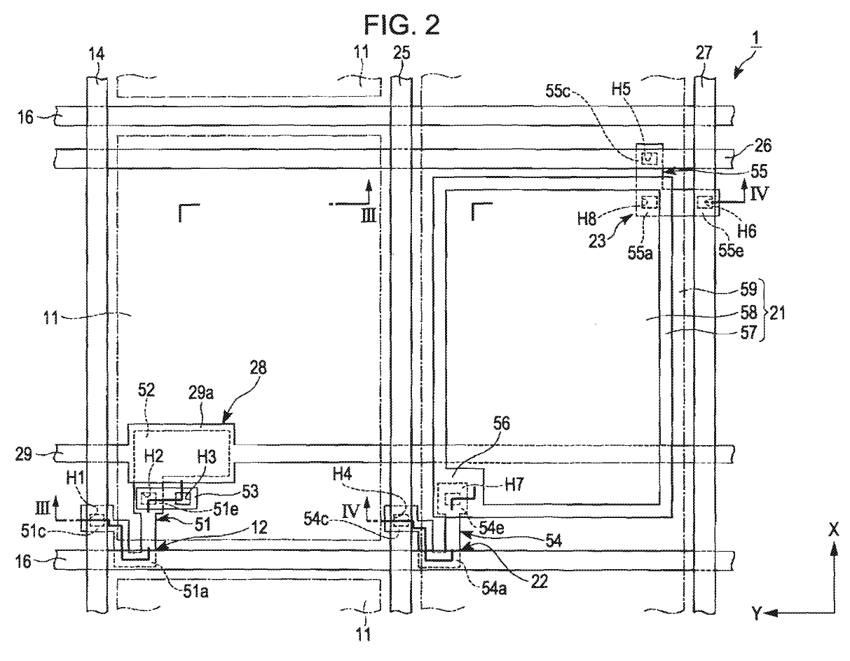

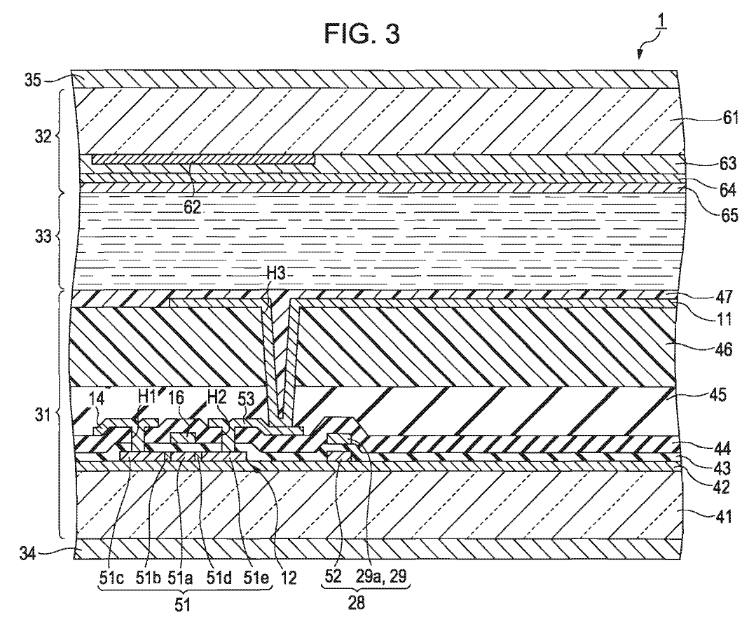

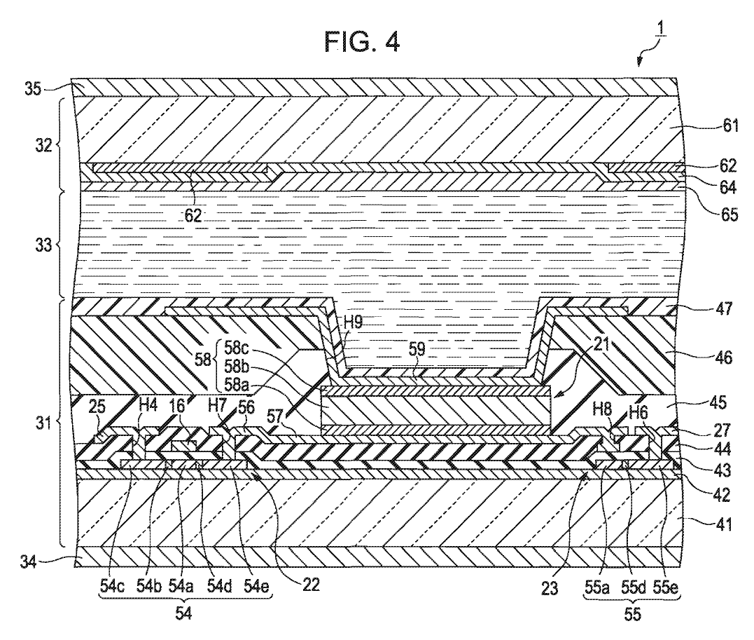

Next, the structure of the liquid-crystal display 1 will be described in detail with reference to FIGS. 2 to 4. In FIG. 2, an opposing substrate is omitted. Moreover, the longitudinal direction of the sub-pixel area and the photodetection area, which are rectangular when viewed in plan, is defined as a X direction, and the lateral direction is defined as a Y direction. As shown in FIGS. 3 and 4, the liquid-crystal display 1 includes an element substrate 31, an opposing substrate 32 that opposes the element substrate 31, a liquid-crystal layer 33 that is disposed between the element substrate 31 and the opposing substrate 32, a polarizing sheet 34 disposed on the outer surface of the element substrate 31 (surface remote from the liquid-crystal layer 33), and a polarizing sheet 35 disposed on the outer surface of the opposing substrate 32. Illumination light is incident on the liquid-crystal display 1 at a side adjacent to the outer surface of the element substrate 31. Moreover, a seal (not shown) is disposed along the outside edge of an area formed between the element substrate 31 and the opposing substrate 32 that oppose each other such that the liquid-crystal layer 33 is sealed with this seal, the element substrate 31, and the opposing substrate 32.

The element substrate 31 includes a substrate body 41 composed of a transmissive material such as glass, quartz, and plastic, and includes an underlying protective film 42, a gate-insulating film 43, a first insulating interlayer 44, a second insulating interlayer 45, a planarizing film 46, and an alignment film 47 laminated on the inner surface of the substrate body 41 (adjacent to the liquid-crystal layer 33) in this order. As shown in FIGS. 2 and 3, the element substrate 31 further includes, in one of the sub-pixel areas, a semiconductor layer 51 and capacitor electrode 52 disposed on the inner surface of the underlying protective film 42, the scanning line 16 and the capacitor line 29 disposed on the inner surface of the gate-insulating film 43, the data line 14 and a connection electrode 53 disposed on the inner surface of the first insulating interlayer 44, and the pixel area 11 disposed on the inner surface of the planarizing film 46. As shown in FIGS. 2 and 4, the element substrate 31 further includes, in one of the photodetection areas, semiconductor layers 54 and 55 disposed on the inner surface of the underlying protective film 42; the scanning line 16 disposed on the inner surface of the gate-insulating film 43; and the reset line 25, the power line 26 (shown in FIG. 2), the sensor line 27, a connection electrode (switching electrode) 56, and the photosensor element 21 disposed on the inner surface of the first insulating interlayer 44.

The underlying protective film 42 is composed of a transmissive silicon oxide such as SiO₂, and covers the inner surface of the substrate body 41 as shown in FIGS. 3 and 4. The gate-insulating film 43 is composed of a transmissive material such as SiO₂, and covers the semiconductor layers 51, 54, and 55 and the capacitor electrode 52 formed on the underlying protective film 42.

The first insulating interlayer 44 is composed of a transmissive material such as SiN, and covers the gate-insulating film 43 and the scanning line 16 and the capacitor line 29 formed on the gate-insulating film 43. The second insulating interlayer 45 is composed of a transmissive material such as SiN as is the first insulating interlayer 44, and covers the data line 14, the photosensor element 21, the reset line 25, the power line 26, the sensor line 27, and the connection electrodes 53 and 56 formed on the first insulating interlayer 44. The planarizing film 46 is composed of a transmissive resin such as acrylic resin, and flattens the unevenness of the inner surface of the second insulating interlayer 45. The alignment film 47 is composed of resin such as polyimide, and covers the pixel area 11 formed on the planarizing film 40. In addition, orientation treatment is applied to the surface of the alignment film 47 such that the orientation of the alignment film 47 corresponds to, for example, the lateral direction of the sub-pixel area (Y direction) shown in FIG. 2.

The semiconductor layer 51 is composed of a semiconductor such as polycrystalline silicon. As shown in FIGS. 2 and 3, the semiconductor layer 51 is formed in an area where the data line 14 partially overlaps with the semiconductor layer 51 via the gate-insulating film 43 and first insulating interlayer 44 when viewed in plan. The semiconductor layer 51 includes a channel region 51a in an area where the scanning line 16 overlaps with the semiconductor layer 51 via the gate-insulating film 43 when viewed in plan. Since the TFT element 12 has a lightly doped drain (LDD) structure, the semiconductor layer 51 includes a highly doped region having a relatively high impurity content and a lightly doped region having a relatively low impurity content in each of the source and drain regions. That is, the semiconductor layer 51 includes a lightly doped source region 51b and a highly doped source region 51c in the source region, and a lightly doped drain region 51d and a highly doped drain region 51e in the drain region. This semiconductor layer 51 primarily constitutes the TFT element 12. The lightly doped source region 51b, the highly doped source region 51c, the lightly doped drain region 51d, and the highly doped drain region 51e are formed by implanting impurity ions in polycrystalline silicon. The channel region 51a is formed by not implanting impurity ions in the polycrystalline silicon.

The capacitor electrode 52 is composed of a semiconductor such as polycrystalline silicon as is the semiconductor layer 51, and is formed in an area where the capacitor line 29 overlaps with the capacitor electrode 52 via the gate-insulating film 43 when viewed in plan. The capacitor electrode 52 is formed by implanting impurity ions in polycrystalline silicon, and continues to the highly doped drain region 51e of the semiconductor layer 51.

The scanning line 16 is disposed along the lateral direction (Y direction) of the sub-pixel area, which is rectangular when viewed in plan. Moreover, the scanning line 16 is formed so as to overlap with the channel region 51a of the semiconductor layer 51 via the gate-insulating film 43 when viewed in plan. This forms a gate electrode. The capacitor line 29 is disposed along the Y direction when viewed in plan, and has a wide portion 29a whose width is larger than those of other portions. The wide portion 29a overlaps with the capacitor electrode 52 via the gate-insulating film 43 when viewed in plan. This wide portion 29a and the capacitor electrode 52 opposing the wide portion 29a via the gate-insulating film 43 constitute the storage capacitor 28.

The data line 14 is composed of a light-absorptive conductive material such as Cr. The data line 14 is disposed along the longitudinal direction of the sub-pixel area (X direction) when viewed in plan, and is connected to the highly doped source region 51c of the semiconductor layer 51 via a contact hole H1 that passes through the gate-insulating film 43 and the first insulating interlayer 44. The connection electrode 53 is disposed along the Y direction when viewed in plan, and connected to the highly doped drain region 51e of the semiconductor layer 51 via a contact hole H2 that passes through the gate-insulating film 43 and the first insulating interlayer 44.

The pixel area 11 is substantially rectangular when viewed in plan, and is composed of a transmissive conductive material such as indium-tin oxide (ITO). Moreover, the pixel area 11 is connected to the connection electrode 53 via a contact hole H3 that passes through the second insulating interlayer 45 and planarizing film 46. With this, the pixel area 11 is connected to the drain of the TFT element 12.

The semiconductor layer 54 is composed of a semiconductor such as polycrystalline silicon as is the semiconductor layer 51. As shown in FIGS. 2 and 4, the semiconductor layer 54 is formed in an area where the reset line 25 partially overlaps with the semiconductor layer 54 via the gate-insulating film 43 and the first insulating interlayer 44 when viewed in plan. The semiconductor layer 54 includes a channel region 54a formed in an area where the scanning line 16 overlaps with the semiconductor layer 54 via the gate-insulating film 43 when viewed in plan, a lightly doped source region 54b and a highly doped source region 54c formed in the source region, and a lightly doped drain region 54d and a highly doped drain region 54e formed in the drain region. This semiconductor layer 54 primarily constitutes the TFT element 22. The semiconductor layer 55 is composed of a semiconductor such as polycrystalline silicon as are the semiconductor layers 51 and 54, and is formed in an area where the sensor line 27 partially overlaps with the semiconductor layer 55 via the gate-insulating film 43 and the first insulating interlayer 44 when viewed in plan. The semiconductor layer 55 includes a channel region 55a, a lightly doped source region (not shown) and a highly doped source region 55c (shown in FIG. 2) formed in the source region, and a lightly doped drain region 55d and a highly doped drain region 55e formed in the drain region. This semiconductor layer 55 primarily constitutes the TFT element 23.

The reset line 25 is disposed along the longitudinal direction of the photodetection area (X direction) when viewed in pan, and is connected to the highly doped source region 54c of the semiconductor layer 54 via a contact hole H4 that passes through the gate-insulating film 43 and the first insulating interlayer 44. The power line 26 is disposed along the lateral direction of the photodetection area (Y direction) when viewed in plan. The power line 26 is connected to the highly doped source region 55c of the semiconductor layer 55 via a contact hole H5 that passes through the gate-insulating film 43 and the first insulating interlayer 44. The sensor line 27 is disposed along the X direction when viewed in plan, and is connected to the highly doped drain region 55e of the semiconductor layer 55 via a contact hole H6 that passes through the gate-insulating film 43 and the first insulating interlayer 44. The connection electrode 56 is disposed on the first insulating interlayer 44, and is connected to the highly doped drain region 54e of the semiconductor layer 54 via a contact hole H7 that passes through the gate-insulating film 43 and the first insulating interlayer 44.

The photosensor element 21 is substantially rectangular when viewed in plan, and functions as a multilayer PIN diode including a lower electrode (sensor electrode) 57, a semiconductor layer 58, and an upper electrode (another sensor electrode) 59 laminated in this order from a side adjacent to the substrate body 41. The upper electrode 59 of the photosensor element 21 serves as a light-receiving surface. The lower electrode 57 is composed of a light-absorptive conductive material such as Cr as are the data line 14, the reset line 25, and the connection electrodes 53 and 56. The lower electrode 57 is substantially rectangular when viewed in plan, and is integrated with the connection electrode 56. Moreover, the lower electrode 57 overlaps with the channel region 55a of the semiconductor layer 55 via a contact hole H8 that passes through the first insulating interlayer 44 and via the gate-insulating film 43. The lower electrode 57 covers the lower surface of the semiconductor layer 58 with a sufficient area so as to function as a light-shielding film that prevents illumination light incident on the liquid-crystal display 1 at the side adjacent to the outer surface of the element substrate 31 from entering the semiconductor layer 58. The material of the lower electrode 57 is not limited to a light-absorptive conductive material such as Cr, and can be a light-reflective conductive material such as Al. The lower electrode 57 composed of such a material can also function as a light-shielding film.

The semiconductor layer 58 is composed of amorphous silicon, and includes a p-type semiconductor layer 58a, an intrinsic layer 58b, and an n-type semiconductor layer 58c laminated in this order from the lower electrode 57. The upper electrode 59 is composed of a transmissive conductive material such as ITO, which is the same material as that of the pixel area 11, and extends in the longitudinal direction of the photodetection area (X direction) when viewed in plan. The upper electrode 59 is connected to the n-type semiconductor layer 58c via a contact hole H9 that passes through the second insulating interlayer 45 and the planarizing film 46. Moreover, the upper electrode 59 is electrically connected to the upper electrodes 59 of other photosensor elements 21 formed in adjacent photodetection areas in the X direction.

On the other hand, as shown in FIGS. 3 and 4, the opposing substrate 32 includes a substrate body 61 composed of a transmissive material such as glass, quartz, and plastic, and includes light-shielding films 62, a color filter layer 63, a common electrode 64, and an alignment film 65 laminated on the inner surface of the substrate body 61 (adjacent to the liquid-crystal layer 33) in this order. Each of the light-shielding films 62 is formed on the surface of the substrate body 61 so as to overlap with the edge portion of the pixel area when viewed in plan, i.e., so as to rim the pixel area. The color filter layer 63 disposed in an area corresponding to the sub-pixel area is composed of, for example, acrylic resin, and includes a color material corresponding to the color displayed in the sub-pixel area. Herein, the color filter layer 63 is not disposed in an area corresponding to the photodetection area such that the intensity of the external light detected in the photodetection area is maintained. When the intensity of the external light detected in the photodetection area is sufficiently ensured, the color filter layer 63 can be disposed in the area corresponding to the photodetection area.

The common electrode 64 is composed of a transmissive conductive material such as ITO as is the pixel area 11. The common electrode 64 covers the light-shielding film 62 and the substrate body 61. The alignment film 65 is composed of a resin such as polyimide as is the alignment film 47, and covers the common electrode 64. In addition, an orientation treatment is applied to the surface of the alignment film 65 such that the orientation of the alignment film 65 corresponds to the lateral direction of the sub-pixel area (Y direction) shown in FIG. 2 and becomes opposite to that of the alignment film 47.

The liquid-crystal layer 33 is of the twisted nematic (TN) type using liquid crystal having a positive dielectric anisotropy. The polarizing sheets 34 and 35 are disposed such that the transmission axes thereof are substantially orthogonal to each other. An optical compensation film (not shown) can be disposed on either or both of the polarizing sheets 34 and 35. This optical compensation film can compensate the phase difference in light passing through the liquid-crystal layer 33 generated when the liquid-crystal display 1 is obliquely viewed, can reduce leakage of light, and thus can increase contrast. The optical compensation film includes combinations of negative uniaxial media and positive uniaxial media, or includes biaxial media whose refractive indices in x, y, and z directions satisfy nx>nz>ny.

### Method for Producing Liquid-Crystal Display

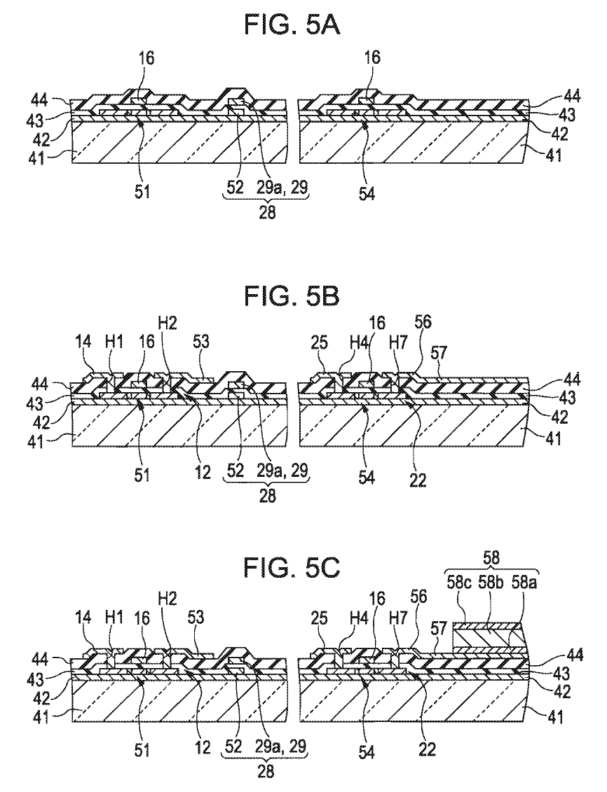

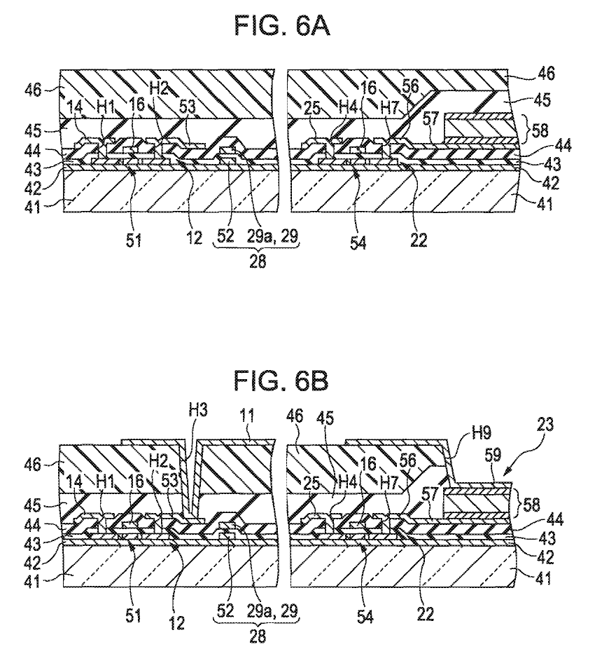

Next, a method for producing the above-described liquid-crystal display 1 will be described with reference to FIGS. 5A to 6B. FIGS. 5A to 6B illustrate a production process of the liquid-crystal display 1. In this embodiment, production of the element substrate 31, which is a feature of the invention, will be described with a particular emphasis.

First, the underlying protective film 42 is formed on the upper surface of the substrate body 41 in a manner similar to those in known technologies. The semiconductor layers 51, 54, and 55 and the capacitor electrode 52 are formed on the underlying protective film 42. The gate-insulating film 43 is formed so as to cover the semiconductor layers 51, 54, and 55 and the capacitor electrode 52, and the scanning line 16 and the capacitor line 29 are formed on the gate-insulating film 43. Furthermore, the first insulating interlayer 44 is formed so as to cover the scanning line 16 and the capacitor line 29 (see FIG. 5A).

Next, the data line 14, the reset line 25, the power line 26 (shown in FIG. 2), the sensor line 27 (shown in FIG. 4), the connection electrodes 53 and 56, and the lower electrode 57 are formed on the first insulating interlayer 44 by, for example, forming a conductive film composed of a light-absorptive conductive material such as Cr on the first insulating interlayer 44 and patterning the film using, for example, photolithography. At this moment, the contact holes H1, H2, H4, H5 (shown in FIG. 2), H6 (shown in FIG. 4), and H7 that pass through the gate-insulating film 43 and the first insulating interlayer 44 and the contact hole H8 (shown in FIG. 4) that passes through the first insulating interlayer 44 are also formed (FIG. 5B). In this manner, the lower electrode 57 of the photosensor element 21, the data line 14, the reset line 25, the power line 26, the sensor line 27, and the connection electrodes 53 and 56 are formed in one step. Moreover, the lower electrode 57 functions as a light-shielding film since the data line 14, the reset line 25, the power line 26, the sensor line 27, the connection electrodes 53 and 56, and the lower electrode 57 are composed of a light-absorptive conductive material such as Cr.

Subsequently, the semiconductor layer 58 including the p-type semiconductor layer 58a, the intrinsic layer 58b, and the n-type semiconductor layer 58c composed of amorphous silicon is formed on the lower electrode 57 (see FIG. 5C). Since the lower surface of the semiconductor layer 58 is entirely covered with the lower electrode 57, the semiconductor layer 58 does not receive light incident on the liquid-crystal display 1 at the side adjacent to the lower surface of the semiconductor layer 58.

Next, the second insulating interlayer 45 is formed so as to cover the data line 14, the reset line 25, the power line 26, the sensor line 27, the connection electrodes 53 and 56, the lower electrode 57, and the semiconductor layer 58. Moreover, the planarizing film 46 is formed on the second insulating interlayer 45. With this, the unevenness formed on the surface of the second insulating interlayer 45 caused by the thickness of the semiconductor layer 58 and the like is flattened (see FIG. 6A). Furthermore, the contact holes H3 and H9 that pass through the planarizing film 46 and the second insulating interlayer 45 are formed.

Subsequently, the pixel area 11 and the upper electrode 59 are formed on the planarizing film 46 by, for example, forming a conductive film composed of a transmissive conductive material such as ITO on the planarizing film 46 and patterning the film using, for example, photolithography. With this the pixel area 11 is connected to the connection electrode 53, and at the same time, the upper electrode 59 is connected to the n-type semiconductor layer 58c of the semiconductor layer 58 (see FIG. 6B). In this manner, the upper electrode 59 of the photosensor element 21 and the pixel area 11 are formed in one step.

Subsequently, the alignment film 47 is formed in a manner similar to those in the known technologies. Since the planarizing film 46 is formed on the second insulating interlayer 45, irregularity in the orientation of the alignment film 47 can be prevented. In this manner, the element substrate 31 is formed. The opposing substrate 32 is formed in a manner similar to those in the known technologies. The element substrate 31 and the opposing substrate 32 are bonded to each other using a seal as described above, and liquid crystal is injected into the space formed by the seal so as to form the liquid-crystal layer 33. Furthermore, the polarizing sheets 34 and 35 are disposed on the element substrate 31 and the opposing substrate 32, respectively. In this manner, the liquid-crystal display 1 shown in FIGS. 1 to 4 is produced.

### Operation of Liquid-Crystal Display

Next, an image-reading operation of the above-described liquid-crystal display 1 will be described. When the tip of a pen (not shown), for example, approaches the liquid-crystal display 1 from outside the opposing substrate 32, the intensity of light incident on the photosensor elements 21 is changed. With this, the strengths of the detection signals D1 to Ds output from the photosensor elements 21 are changed. The photodetection-control circuit 24 specifies the photodetection areas where external light is blocked by the pen on the basis of the changes in the strengths of the detection signals D1 to Ds. In this manner, images are read by the liquid-crystal display 1.

### Electronic Device

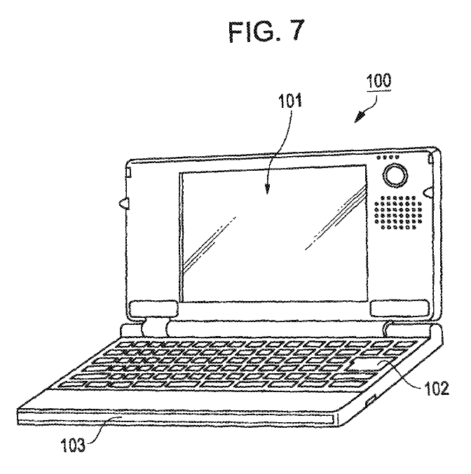

The liquid-crystal display 1 having the above-described structure can be used for, for example, a display section 101 of a mobile personal computer (electronic device) 100 shown in FIG. 7. This mobile personal computer 100 includes the display section 101 and a body 103 having a keyboard 102.

In accordance with the liquid-crystal display 1, the method for producing the liquid-crystal display 1, and the mobile personal computer 100 according to the above-described embodiments, the lower electrodes 57 serving as the electrodes of the photosensor elements 21 and the data lines 14, the reset lines 25, the power lines 26, the sensor lines 27, and the connection electrodes 53 and 56 serving as the electrodes connected to the TFT elements 12, 22, and 23 are formed on the same first insulating interlayer 44. Thus, the production process can be simplified, and at the same time, flexibility in designing of the photosensor elements 21 can be improved, resulting in photosensor elements 21 with higher sensitivity. Moreover, the formation of the pixel areas 11 and the upper electrodes 59 on the same planarizing film 46 can also simplify the production process.

The data lines 14, the reset lines 25, the power lines 26, the sensor lines 27, the connection electrodes 53 and 56, and the lower electrodes 57 are composed of light-absorptive conductive materials such as Cr, and at the same time, the lower electrodes 57 entirely cover the lower surfaces of the corresponding semiconductor layers 58. Thus, backlight heading to the lower surfaces of the photosensor elements 21 can be blocked such that the photosensor elements 21 do not receive the light, resulting in an increase in photodetection accuracy in the photodetection areas. Moreover, the driving speed of the TFT elements 12, 22, and 23 can be enhanced since the TFT elements 12, 22, and 23 are transistors that are mainly composed of polycrystalline silicon. In addition, since the photosensor element 21 is a PIN diode that is mainly composed of amorphous silicon, the photodetection efficiency using the photosensor elements 21 and the accuracy in photodetection in the photodetection areas are improved. Furthermore, even when the TFT elements 12, 22, and 23 and the photosensor elements 21 are formed on different layers, the unevenness formed by these elements can be flattened by the planarizing film 46 formed on the second insulating interlayer 45. Accordingly, the alignment film 47 can be formed on a flat surface. With this, irregularity in the initial orientation of liquid-crystal molecules can be prevented.

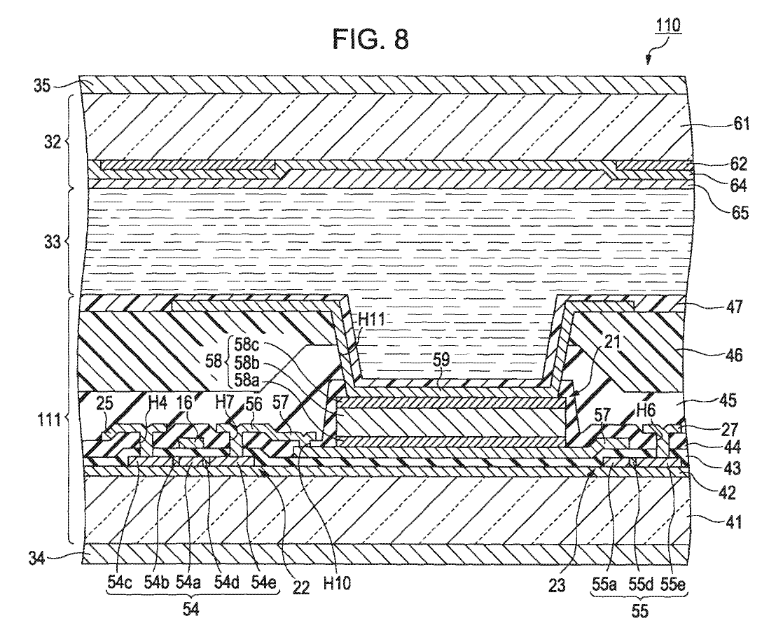

The invention is not limited to the above-described embodiments, and various modifications are possible within the scope of the invention. For example, in the above-described embodiments, the lower electrodes of the photosensor elements and the wiring lines connected to the drains of the TFT elements are formed on the first insulating interlayer. However, as in a liquid-crystal display 110 shown in FIG. 8, the lower electrode of the photosensor element and the scanning line 16 connected to the gate of the TFT element 22 can be formed on the gate-insulating film 43 in an element substrate 111. In this case, the scanning line 16 functions as a switching electrode. Herein, part of the lower electrode 57 faces the channel region 55a of the TFT element 23 via the gate-insulating film 43. Moreover, the connection electrode 56 and the lower electrode 57 are connected to each other via a contact hole H10 that passes through the first insulating interlayer 44. Furthermore, the upper electrode 59 and the n-type semiconductor layer 58c of the semiconductor layer 58 are connected to each other via a contact hole H11 that passes through the insulating interlayers 44 and 45 and the planarizing film 46.

Moreover, a photodetection area is provided for each set of three sub-pixel areas that output red, green, and blue light. However, a photodetection area can be provided for each of the three sub-pixel areas, or can be provided for a plurality of sets of the three sub-pixel areas. Furthermore, the liquid-crystal display is a color liquid-crystal display system that displays three colors of R, G, and B. However, the liquid-crystal display can be a monochrome display system that displays a single color of any of or other than R, G, and B, or can be a display system that displays two colors or four or more colors. The color filter layer 63 can be disposed on the element substrate instead of on the opposing substrate.

The TFT elements that switch the drive of the sub-pixel areas and the photodetection areas are mainly composed of polycrystalline silicon. However, the TFT elements can be mainly composed of amorphous silicon. Moreover, the TFT elements are used as switching elements for switching the drive of the sub-pixel areas and the photodetection areas. However, the invention is not limited to this, and other driving elements such as thin-film diode (TFD) elements can be used as the switching elements.

The photosensor elements disposed in the photodetection areas are mainly composed of amorphous silicon. However, the photosensor elements can be mainly composed of polycrystalline silicon. Moreover, the photosensor elements disposed in the photodetection areas are formed of multilayer PIN diodes, but the invention is not limited to this. Furthermore, the lower electrodes of the photosensor elements are composed of a light-absorptive or light-reflective material. However, other materials can be used as long as the accuracy in photodetection by the photosensor elements can be maintained. Moreover, the lower electrodes do not need to entirely cover the lower surfaces of the corresponding photosensor elements. Furthermore, the upper electrodes of the photosensor elements and the pixel areas are formed on the same layer in one step. However, these components can be formed in different steps. The planarizing film is formed on the second insulating interlayer. However, the alignment film can be formed on the second insulating interlayer without forming the planarizing film as long as the orientation of the alignment film can be made uniform.

The liquid-crystal display has an electrode structure in which the pixel area is formed in the element substrate and the common electrode is formed in the opposing substrate. However, the liquid-crystal display can adopt an electrode structure using a so-called transverse electric field such as the in-plane switching (IPS) mode or the fringe-field switching (FFS) mode; in which an electric field whose directions are parallel to the substrate surface is generated in the liquid-crystal layer by forming the pixel area and the common electrode in the element substrate. Moreover, twisted nematic (TN) liquid crystal is used for the liquid-crystal layer. However, the invention is not limited to this, and other liquid crystals such as vertically aligned nematic (VAN) mode liquid crystal, electrically controlled birefringence (ECB) mode liquid crystal, and optically compensated bend (OCB) mode liquid crystal can also be used.

The electronic device including the liquid-crystal display is not limited to the mobile personal computer, and can be other devices such as cellular phones, personal digital assistants (PDAs), personal computers, notebook computers, workstations, digital still cameras, car-mounted monitors, car navigation devices, head-up displays, digital video cameras, television receivers, video tape recorders of the viewfinder or direct-view type, pagers, electronic notepads, calculators, electronic books, projectors, word processors, videophones, point-of-sale (POS) terminals, devices including touch panels, and illuminating devices.

What is claimed is:

1. A liquid-crystal display having a plurality of pixel areas and a plurality of photodetection areas for detecting light disposed in a two-dimensional manner, comprising:
first switching elements each provided for the corresponding pixel area and switching the drive of the corresponding pixel area; and
second switching elements formed on the same layer as the first switching elements and each switching a photosensor element provided for the corresponding photodetection area, wherein
first sensor electrodes connected to the photosensor elements are formed on the same layer as switching electrodes connected to the second switching elements.

2. The liquid-crystal display according to claim 1, wherein the first sensor electrodes are composed of a light-reflective material or a light-absorptive material, and cover the lower surfaces of the photosensor elements.

3. The liquid-crystal display according to claim 1, wherein second sensor electrodes connected to the photosensor elements are formed on the same layer as display electrodes provided for the pixel areas.

4. The liquid-crystal display according to claim 1, wherein the first switching elements and the second switching elements are thin-film transistors.

5. The liquid-crystal display according to claim 4, wherein the first switching elements and the second switching elements are mainly composed of polycrystalline silicon.

6. The liquid-crystal display according to claim 1, wherein the photosensor elements are multilayer PIN diodes.

7. The liquid-crystal display according to claim 6, wherein the photosensor elements are mainly composed of amorphous silicon.

8. The liquid-crystal display according to claim 1, further comprising:
a planarizing film formed on the first switching elements, the second switching elements, and the photosensor elements so as to flatten the surfaces of the elements; and
an alignment film formed on the planarizing film so as to regulate the initial orientation of liquid-crystal molecules.

9. A method for producing a liquid-crystal display having a plurality of pixel areas and a plurality of photodetection areas for detecting light disposed in a two-dimensional manner, comprising:
forming of first switching elements that drive the pixel areas and second switching elements that drive the photodetection areas on the same layer; and
forming of photosensor elements driven by the second switching elements, wherein
first sensor electrodes connected to the photosensor elements are formed on the same layer as switching electrodes connected to the second switching elements.

10. An electronic device comprising:
the liquid-crystal display according to claim 1.
